(19) United States
(12) Patent Application Publication
(10) Pub. No.: US 2002/0086268 A1
(43) Pub. Date: Jul. 4, 2002

(54) Grammar instruction with spoken dialogue

(76) Inventor: Zeev Shpiro, Ra'anana (IL)

Correspondence Address: David A. Hall, Heller Ehrman White & McAuliffe LLP, 7th Floor, 4350 La Jolla Village Drive, San Diego, CA, 92122-1246, US

(21) Appl. No.: 10/023,518

(22) Filed: Dec. 18, 2001

Related U.S. Application Data
(60) Provisional application No. 60/256,537, filed on Dec. 18, 2000.
(60) Provisional application No. 60/256,557, filed on Dec. 18, 2000.
(60) Provisional application No. 60/256,558, filed on Dec. 18, 2000.
(60) Provisional application No. 60/256,560, filed on Dec. 18, 2000.

(51) Int. Cl. G09B 19/00

(52) U.S. Cl. 434/156

(57) ABSTRACT

A computer assisted learning environment in which an interactive dialogue occurs between a user and an instructional process of an electronic device, wherein the user performs a speaking task and the user's performance is analyzed. The user is presented with a prompt at the electronic device and, in response, produces a spoken input, which is received by the electronic device, and provided to the instructional process. The instructional process analyzes the received spoken input using speech recognition techniques and provides feedback concerning the grammar of the user input. The analysis may also include Spoken Language skills evaluation and in this case the feedback will be extended to cover these aspects as well.

### REFERENCE TO PRIORITY DOCUMENT

This application claims priority of co-pending U.S. Provisional Patent Application Serial No. 60/256,560 entitled “Grammar Instruction with Spoken Dialogue” by Z. Shpiro, filed Dec. 18, 2000. Priority of the filing date of Dec. 18, 2000 is hereby claimed, and the disclosure of the Provisional Patent Application is hereby incorporated by reference.

### BACKGROUND OF THE INVENTION

1. Field of the Invention

This invention relates generally to educational systems and, more particularly, to computer assisted language instruction.

2. Description of the Related Art

As commerce becomes more global, the need for understanding second languages and being able to communicate in them is growing. The Foreign Language/Second Language training industry therefore is a rapidly expanding industry, and is now investigating how to apply new technologies, such as the Internet, to such training. Current language training product elements include printed materials, audio cassettes, software applications, video cassettes, and Internet sites through which information and distance learning lessons are provided. Several attempts have been made to apply various Foreign Language/Second Language training processes to the Internet world, but most of them are simple conversions of printed, audio, and video material into a computer client-server application; i.e. the Internet applications are typically not offering new features beyond the current features offered by conventional media.

Language grammar is an important element in language training. The grammar of a language is divided into two categories: grammar of the written language and conversational grammar. Grammar is presently being taught primarily in the classroom with textbooks and a human teacher. One of the most popular English Grammar books is English Grammar, by Raymond Murphy, Cambridge University Press.

Teaching language grammar traditionally involves the grammar of the written language. This type of instruction is a challenge to provide, and many attempts were and are still being made to find the most appropriate solution. Most students find the subject unappealing and of little interest to them, and teachers find it difficult to teach students who display little or no interest in the subject matter. There are areas, in fact, where grammar is no longer being taught in schools at all due to the dryness of the subject and the lack of more interesting and stimulating methods by which to teach grammar.

Teaching conversational grammar using the traditional means of text and graphics (or any method without actual spoken dialogue) seems unnatural, causes problems with learning proper conversational grammar, and is hard to successfully achieve. The student is not given the “feel” for the spoken language. There are dialogue exercises for grammar in current textbooks. For example, exercises in which a student is asked to speak with a dialogue partner using only question-type sentences. There are many grammar exercises that are available in a text format, such as exercises that ask the student to provide an appropriate preposition for a phrase, and the like.

Speech recognition technology is an advanced technology with commercial applications integrated into products. Systems for teaching pronunciation skills, based on speech recognition technology, for identifying user errors, and providing corrective feedback are known. For example, pronunciation and fluency evaluation and implementation techniques, based on speech recognition technology, are described in two US patents granted to Stanford Research Institute (SRI) of Palo Alto, Calif., USA: U.S. Pat. Nos. 6,055,498 and 5,634,086.

Computer assisted language training is a developing area and several products for teaching language by computer are available at present. Some of these products also attempt to teach the various aspects of language grammar, but do so only via interactive text and graphic methods. Known systems for interactive teaching of language skills are limited to instruction regarding pronunciation and spoken vocabulary.

From the discussion above, it should be apparent that there is a need for instruction in spoken grammar that encourages spoken dialogue and evaluates speaking skills. The present invention fulfills this need.

### SUMMARY OF THE INVENTION

The invention provides a computer assisted learning environment in which an interactive dialogue occurs between a user and an electronic device, wherein the user performs a speaking task and an instructional process analyzes the user's performance. The user is presented with a prompt at the electronic device and, in response, produces a spoken input, which is received by the electronic device. The instructional process analyzes the received spoken input using speech recognition techniques and provides feedback concerning the user's response and the grammar of a target language. The feedback may be as simple as an “OKAY” message and/or identification of a user problem (for example, “You said ‘went’ instead of ‘will go’”) and/or may include identification of a user grammatical problem (for example, “You are mixing between past and future tenses”), and/or grammar instructions (for example, “Say it again using future tense”), speech corrections, hints, system instructions, and the like. Thus, the present invention relates to the teaching of grammar via oral dialogue with an electronic computing device. In this way, the invention supports an interactive dialogue between a user and an electronic device to provide the user with feedback relating to the grammar of the target language.

In one aspect of the invention, the user is notified of grammatical errors that occur during the user's spoken performance of speaking exercises. Thus, the instructional process examines the user's spoken language skills (as pronunciation) and, in addition, examines the content of the user's response for grammatical errors. These grammatical errors are identified by comparing the user's response with expected responses. The comparison preferably occurs between correct and incorrect answers, and includes comparison to responses spoken by speakers who are native speakers in the target language and responses spoken by non-native speakers in the target language, for better identification of responses from a variety of student speakers. Thus, the instructional process, using speech recognition techniques, attempts to match the user's response to a selection from the expected answers database. In this way, the invention better supports grammatical instruction to non-native speakers of a target language.

Other features and advantages of the present invention should be apparent from the following description of the preferred embodiment, which illustrates, by way of example, the principles of the invention.

### BRIEF DESCRIPTION OF THE DRAWINGS

FIG. 1 is a block diagram of an interactive language teaching system constructed in accordance with the present invention.

FIG. 2A and FIG. 2B together comprise a flow diagram that illustrates the operations performed by the system shown in FIG. 1.

FIG. 3A is an illustration of a lesson exercise that is presented to a student user of the system illustrated in FIG. 1.

FIG. 3B is an illustration of the lesson flow through the exercise of FIG. 3B.

### DETAILED DESCRIPTION

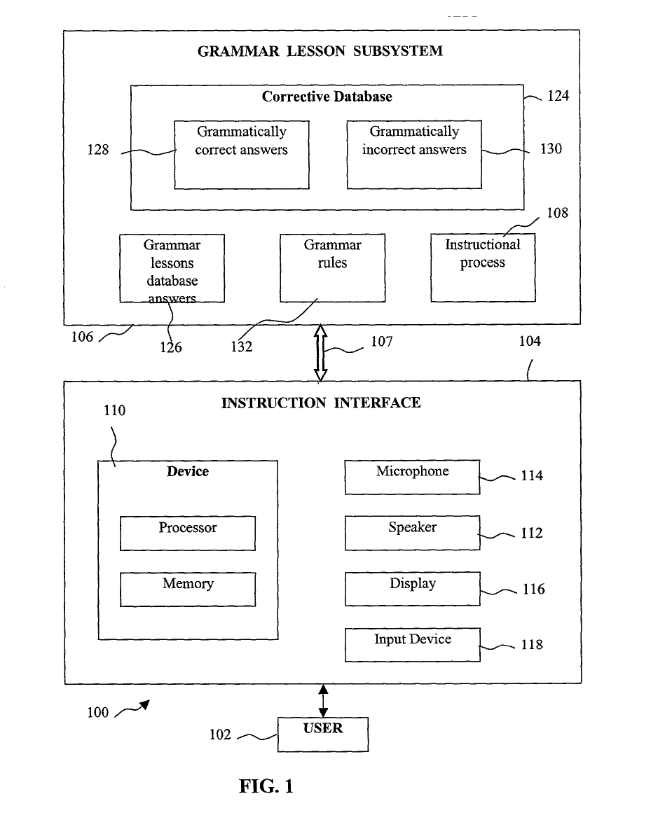

FIG. 1 is a representation of a system 100 that provides interactive language grammar instruction in accordance with the present invention. A user 102 communicates with an instructional interface 104, and the instructional interface communicates with a grammar lesson subsystem 106 over a network communications line 107 to send and receive information through an instructional process 108. The communications line can comprise, for example, a network connection such as an Internet connection or a local area network connection. Alternatively, the instruction interface 104 and the lesson subsystem 106 may be integrated into a single product or device, in which case the connection 107 may be a system bus. The instruction interface subsystem 104 includes an electronic dialogue device 110 that may comprise, for example, a conventional Personal Computer (PC), such as a computer having a processor and operating memory. The processor may comprise one of the “Pentium” family of microprocessors from Intel Corporation of Santa Clara, Calif., USA or the “PowerPC” family of microprocessors from Motorola, Inc. of Chicago, Ill., USA. Alternatively, the electronic device 110 may comprise a personal digital assistant or a telephone device or a hand-held computing device. As noted above, the grammar lesson subsystem 106 and instruction interface subsystem 104 may be incorporated into a single device. If the two units 104, 106 are separate, then the grammar lesson subsystem 106 may have a construction similar to that of the user PC 110, having a processor and associated peripheral devices 112-118.

The instruction interface subsystem 104 is preferably equipped with an audio module 112 that reproduces spoken sounds. The audio module may include a headphone through which the user may listen to sound produced by the computer, or the audio module may include a speaker that reproduces sound into the user's environment for listening. The system 100 also includes a microphone 114 into which the user may speak, which may be combined with the microphone in an audio module. The system also includes a display 116 on which the user may view graphics and text containing instructional exercises and diagnostic or instructional messages. The user's spoken words are converted by the microphone into a digital representation that is received in memory of the electronic device 110. In the preferred embodiment, the digitized representation is further converted into a parametric representation, in accordance with known speech recognition techniques, before it is provided from the user device 110 to the grammar lesson subsystem 106. The device 110 may also include a user input device 118, such as a keyboard and/or a computer mouse.

As noted above, the grammar lesson subsystem 106 supports an instructional process 108. The instructional process is a computational process executed by, for example, a processor and memory combination of the lesson subsystem 106, where the grammar lesson subsystem comprises a network server with a processor and memory, such as typically included in a Personal Computer (PC) or server computer. In the preferred embodiment, the grammar lesson subsystem also includes an expected answers database 124 and a grammar lessons database 126. The grammar lessons database is a source of grammar exercises and instructional materials that the user 102 will view and listen to using the electronic device 110. The expected answers database 124 of the grammar lesson subsystem 106 includes both grammatically correct answers to the lesson exercises 128 and grammatically incorrect answers to the exercises 130.

The instructional process 108 will match inputs from the user 102 to the correct and incorrect answers 128, 130 and will attempt to match the user inputs to one or the other type of answer. If the instructional process finds no match, or cannot determine the content of the response provided by the user, the instructional process may request that the user repeat the response or provide a new one. The grammar lesson subsystem 106 includes a grammar rules module 132 that provides instructional feedback and suggestions to the user for proper spoken grammar. As an alternative to determining correct answers by performing an answer look-up scheme with the expected answers database 124, the grammar rules module 132 may include rules from which the instructional process may determine correctness of answers.

Thus, the user 102 receives a combination of graphical, text, and audio instruction from the grammar lesson subsystem 106 and responds by speaking into a microphone of a user electronic device, where the user's speech is digitized, converted into a parametric representation, and is then provided to the instructional process 108 for evaluation. The instructional process determines the response and provides feedback, as was described above and further below.

General Operation

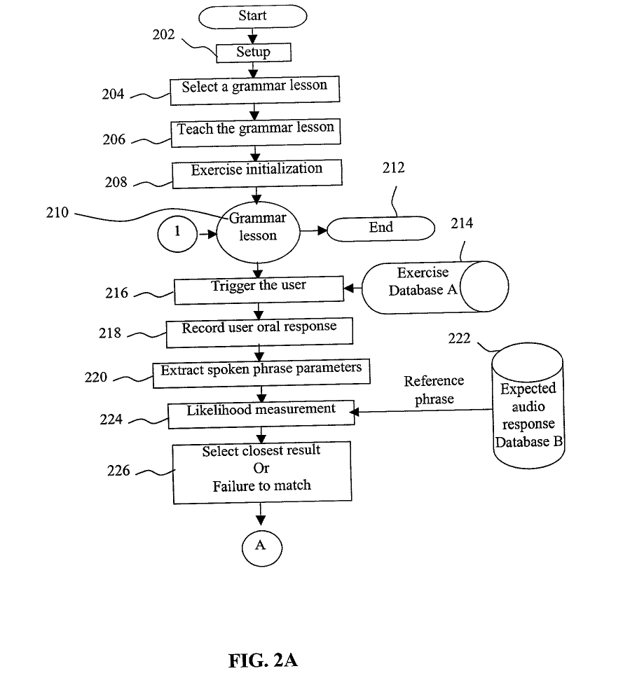

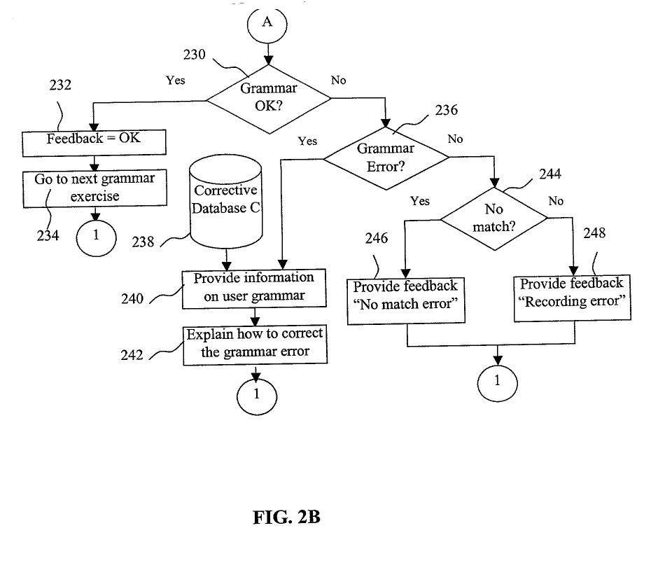

The operation of the system shown in FIG. 1 is illustrated by the flow diagram of FIG. 2. The operation begins with a setup procedure 202, which includes a microphone adjustment phase and a phase for training in the use of the microphone. This procedure ensures that the user is producing sufficient volume when speaking so that accurate recordings may be made. Such calibration procedures are common in the case of, for example, many computer speech recognition systems, such as computer dictation applications and computer assisted control systems. The calibration setup procedure is represented by the flow diagram box numbered 202.

Next, at the flow diagram box numbered 204, the user selects a grammar lesson. The lesson may be a lesson of special interest to the user or may simply be the next lesson in a sequential lesson plan. A grammar lesson includes a sequence of presentation materials, along with corresponding exercises. After selection of the lesson, the system teaches the grammar lesson, as indicated by the flow diagram box numbered 206. This operation provides an explanation about the selected topic of grammar such that the explanation includes both graphical elements that are displayed on the computer screen 116 and includes audible or spoken elements that are played for the student user through the audio module 112 (FIG. 1).

After the presentation of a grammar lesson, which provides instructional information, the user will be asked to complete a learning exercise. Preferably, a learning exercise includes an exercise initialization process 208 in which the student specifies a lesson with which the session will begin. This permits the student user to begin a session with any one of the exercises in the selected lesson, and thereby permits students of superior ability to have rapid advancement through the lesson, and also permits students to leave a lesson and return where they left off, without unnecessary repetition. Thus, the performance of the exercises begins with an initialization step, represented by the flow diagram box numbered 208, in which the user may select a specifically numbered exercise.

To begin the grammar lesson exercise, a grammar lesson is retrieved and provided to the user, as indicated by the flow diagram box numbered 210. If the last grammar lesson has been finished, then processing of this module is halted, as indicated by the “END” box 212. If one or more grammar lessons remain in the present exercise, then system processing resumes with the next grammar lesson, which is retrieved from the exercise database 214, and then at the flow diagram box numbered 216, where the user response is triggered. The next few steps, comprising the presentation of a grammar lesson and the triggering of a user response through the bottom of the flow diagram (FIG. 2B), are repeated until a user has cycled through the response exercises of the selected lesson. In presenting the grammar lesson, the information provided to the user preferably includes audio and graphical information that are played audibly for the student and displayed visually on the display 116 of the user's electronic device.

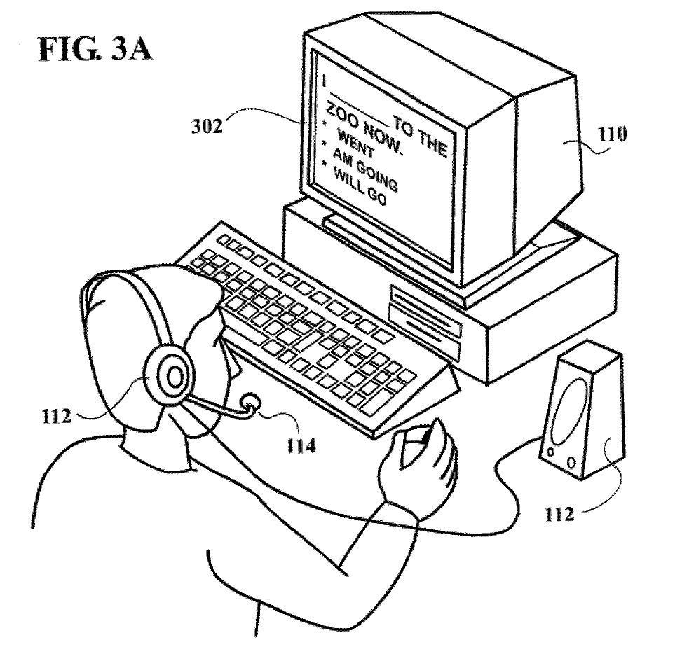

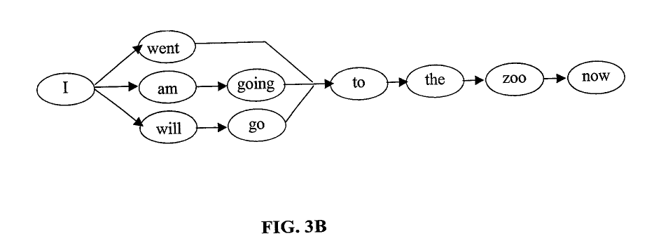

FIG. 3A shows a user being presented with an exercise of the grammar lesson, with exemplary text shown on a representation of the display screen. The exemplary exercise of FIG. 3A shows that the computer display screen 302 presents the user with an English language sentence, “I ______ to the zoo now.” The student is asked to fill in the blank area of the sentence, speaking the entire sentence into the microphone 114. Three choices are presented to the user for selection, either “went”, or “am going”, or “will go”. The presentation of the exercise on the display screen prompts the student user to provide a spoken response, thereby eliciting a user response and comprising a trigger event to the user response. Thus, the user is asked to give his or her answer to a grammar question that appears on the display, and which may optionally be played by the audio module 114 of the system as well, for the user to hear. Thus, the user selects an answer from several grammar phrase possibilities that are displayed on the screen and vocalizes the answer by repeating the complete sentence, inserting the phrase selected by the user as the correct response.

Next, as represented by the flow diagram box numbered 218, the system records the user oral response elicited by the trigger event. The recording will comprise the user speaking into the microphone or some other similar device that will digitize the user's response so it can be processed by the computer system 100. In the next operation, represented by the FIG. 2 flow diagram box numbered 220, the instructional process extracts spoken phrase parameters of the user's response for examination and evaluation. Those skilled in the art will understand how to extract spoken phrase parameters of a user response, such as may be performed by the aforementioned voice recognition programs. For example, the user's response may be broken up into phrases comprising the words of the alternative choices, as shown in the graphical representation of FIG. 3B.

The instructional process will consult an expected answers database that includes expected responses in audio format, indicated at box 222, to extract one or more reference phrases against which the user's response is examined. At the flow diagram box numbered 224, the system performs a likelihood measurement that compares the user's vocal response with a selection of expected grammar correct and incorrect phrases extracted from the system's expected answers database to identify the most likely one of the reference responses that matches the elicited response actually received from the user. The example as illustrated in FIG. 3B shows a diagram that illustrates various ways of saying a sentence. The system analyzes the user's vocal response (the input) by dividing it into phrases (or words). The response is then reviewed phrase by phrase to determine whether the user has responded correctly. After the comparison has been completed, the system will select the closest or most likely result. The system decides which phrase from among the options displayed on the screen is the closest to the user's response (the input). The operation of the language teaching system then continues with the operation shown in FIG. 2B indicated by the page connector.

In FIG. 2B, the system first checks to determine if the user's actual response contains the correct grammar. This checking is represented by the decision box numbered 230. If the user's actual response is identified as a correct grammatical response, an affirmative outcome at the decision box, then the system will provide an approval message to the user (box 232), who may wish to continue with the next exercise (box 234). The continuation with the next exercise is indicated by the return of operation to box 210. It should be noted, however, that even a grammatically correct response may prompt corrective feedback if the user's pronunciation of the response bears improvement. In that case, where the system can identify the user's response as being grammatically correct but can also determine that the user's pronunciation is not acceptable, then the system will generate corrective feedback that includes a pronunciation suggestion. Thus, the system will analyze user responses along two dimensions, for content (grammar) and for the way the words of the response were produced (spoken language skills such as pronunciation).

If the user's spoken response is not identified as grammatically correct, a negative outcome at the decision box 230, then the system will determine if the user's error was an error of grammar, or some other type of error. The system performs this operation by matching the phrases of the user's spoken response to the alternatives shown on the electronic device display and identifying a grammatical error. If the error was grammatical, an affirmative outcome at box 236, then the system attempts to provide the user with corrective feedback. The system does this by first consulting the corrective database at box 238. From the corrective database or grammar rules module, the instructional process locates the corrective feedback that corresponds to the reference grammatical error that is indicated as most likely to be the actual user response. In the preferred embodiment, the provided feedback may simply comprise an “OKAY” message, if the user's response contains no error. If there is an error, the feedback includes a message that can be as simple as informing the user “You made a mistake” and/or identification of the user problem (for example, indicating “You said ‘went’ instead of ‘will go’”) and/or may include identification of the user grammatical problem (for example, “You were using the past tense of go-went instead of the future tense of will go. You are mixing between past and future tenses”), and/or grammar instructions (for example, “You made a mistake; please say it again using the future tense”), speech corrections, hints, system instructions, and the like. Thus, the feedback corresponding to the user's error can comprise any one of the messages, or may comprise a combination of one or more of the messages.

At the flow diagram box numbered 240, the user is provided with the corrective feedback from the database. The flow diagram box numbered 242 indicates that the corrective feedback is displayed to the user and explains how the user may correct the grammatical error. The feedback may involve, for example, providing an explanation of the correct selection of words in the exercise and also suggestions for the correct pronunciation of words in the user's response. The lesson processing then continues with the next exercise at box 210.

If the user's error was not an error of grammar, a negative outcome at the decision box 236, then at the decision box numbered 244 the system determines the nature of the response failure. If there was a failure to match between the user's response and one of the likely responses contained in the expected answers database, an affirmative outcome at box 244, then the system provides an indication of the match failure with a “No match error” message at the flow diagram box numbered 246. If the user's response was simply not recorded properly, a negative outcome at the decision box 244, then the system will generate a “recording error” message to alert the user at box 248. As a result, the user may repeat the sound calibration step or check the computer equipment. In the event of either failure message, the user will repeat the exercise, so that operation will return to box 210. In this way, the invention supports grammatical instruction to non-native speakers of a target language.

The process described above is performed under control of computer operating instructions that are executed by the user electronic device and the grammar lessons subsystem. In the respective systems, the operating instructions are stored into the memory of the electronic device and into accompanying memory utilized by the instructional process of the grammar lessons subsystem.

The present invention has been described above in terms of a presently preferred embodiment so that an understanding of the present invention can be conveyed. There are, however, many configurations for grammar instruction dialogue systems not specifically described herein but with which the present invention is applicable. The present invention should therefore not be seen as limited to the particular embodiments described herein, but rather, it should be understood that the present invention has wide applicability with respect to grammar instruction dialogue systems generally. All modifications, variations, or equivalent arrangements and implementations that are within the scope of the attached claims should therefore be considered within the scope of the invention.

I claim:

1. A method of providing language instruction, the method comprising:
presenting a prompt to a user at an electronic device of a computer instructional system;
receiving a user spoken input in response to the device prompt at the electronic device, thereby comprising a user-device dialogue; and
analyzing the received user spoken input using speech recognition and providing feedback concerning the grammar of a target language in response to the analyzed user input.

2. A method as defined in claim 1, further including analyzing the content of the user spoken input to provide the appropriate feedback concerning conversational grammar of the target language.

3. A method as defined in claim 1, further including analyzing the content of the user spoken input for grammatical correctness in accordance with grammar rules of the target language.

4. A method as defined in claim 3, further including providing a corrective message if the computer instructional system determines that the user spoken input is grammatically incorrect.

5. A method as defined in claim 1, wherein analyzing the received user spoken input concerning grammar comprises determining grammatical correctness by comparing the user spoken input to a database of potential answers that includes grammatically correct and incorrect answers relative to the prompt.

6. A method as defined in claim 5, further including providing a corrective message if the computer instructional system determines that the user spoken input is grammatically incorrect.

7. A method as defined in claim 1, wherein analyzing the received user spoken input comprises utilizing speech recognition that accommodates non-native speakers of the target language.

8. A method as defined in claim 1, further including:
utilizing speech recognition to analyze the received user spoken input; and
identifying user spoken language errors in the target language.

9. A language instruction system comprising:
an electronic dialogue device including a display screen, microphone, and audio playback device;
a grammar lesson subsystem; and
an instruction interface that supports communications between the electronic dialogue device and the grammar lesson subsystem;
wherein the grammar lesson subsystem receives a user spoken input in response to a device prompt at the electronic dialogue device, thereby comprising a user-device dialogue, and wherein the grammar lesson subsystem utilizes speech recognition to analyze the received user spoken input and to provide feedback concerning conversational grammar of a target language.

10. A system as defined in claim 9, wherein the system analyzes the content of the user spoken input to provide the feedback concerning conversational grammar for the target language.

11. A system as defined in claim 9, wherein the system analyzes the content of the user spoken input for grammatical correctness in accordance with grammar rules of the target language.

12. A system as defined in claim 11, wherein the system provides a corrective message if the system determines that the user spoken input is grammatically incorrect.

13. A system as defined in claim 9, wherein the system determines grammatical correctness by comparing the user spoken input to a database of potential answers that includes grammatically correct and incorrect answers relative to the prompt.

14. A system as defined in claim 13, wherein the system provides a corrective message produced according to grammar rules of the target language if the system determines that the user spoken input is grammatically incorrect.

15. A system as defined in claim 9, wherein the system analyzes the received user spoken input by utilizing speech recognition that accommodates non-native speakers of the target language.

16. A system as defined in claim 9, wherein the system utilizes speech recognition to analyze the received user spoken input and identifies user spoken language errors in the target language.
